(19) United States
(12) Patent Application Publication
(10) Pub. No.: US 2013/0115346 A1
(43) Pub. Date: May 9, 2013

(54) METHOD FOR PREPARING PURIFIED BEVERAGE FOR RENAL FAILURE PATIENTS AND PURIFIED BEVERAGE PREPARED THEREBY

(71) Applicant: Hyuk Ho KWON, Uiwang-si (KR)

(72) Inventor: Hyuk Ho KWON, Uiwang-si (KR)

(21) Appl. No.: 13/309,656

(22) Filed: Dec. 2, 2011

(30) Foreign Application Priority Data
Nov. 4, 2011 (KR) 10-2009-0114371

(51) Int. Cl. A23L 2/74; A23L 2/00; A23C 11/10; A23C 9/142; A23C 9/146; A23L 2/78; A23L 2/02

(52) U.S. Cl. 426/271; 426/490; 426/590

(57) ABSTRACT

A method for preparing a purified beverage for renal failure patients and a purified beverage for renal failure patients prepared by the method comprises: introducing a raw beverage containing a high concentration of phosphorus or potassium into a filter unit such that the raw beverage flows through the inner side of the filter unit in a first direction; and introducing a perfusion into the filter unit such that the perfusion flows through the outside of the filter unit in a second direction, and the raw beverage and the perfusion are circulating in opposite direction, whereby phosphorus or potassium in the raw beverage moves to the perfusion effectively, thereby preparing a purified beverage containing a low concentration of phosphorus or potassium.

### CROSS REFERENCES

Applicant claims foreign priority under Paris Convention to Korean Patent Application No. 10-2009-0114371 filed Nov. 4, 2011, with the Korean Intellectual Property Office, where the entire contents are incorporated herein by reference.

### BACKGROUND OF THE INVENTION

1. Field of the Invention

The present invention relates to a method for preparing a purified beverage for renal failure patients, which contains fewer components harmful to the renal failure patients, and to a purified beverage for renal failure patients prepared by the method.

2. Description of the Prior Art

Fruits and vegetables are rich in potassium, vitamins, minerals, dietary fibers and the like, and peoples are recommended to abstain from meat and eat fresh fruits and vegetables often. Particularly, potassium is easily excreted through the kidneys, has blood pressure-lowering effects and is harmless to normal people.

However, renal failure patients cannot excrete specific ions with urine from the body due to renal function impairment. Particularly, when potassium accumulates in renal failure patients, it can cause acute fatal complications such as heart attack, leading to death. Indeed, it was reported that hyperkalemia is the leading cause of death in renal failure patients. Significant increases in serum potassium levels cause cardiac arrest, even leading to death in severe cases. Also, phosphorus is a typical uremic toxin that, when accumulates continuously in the body, binds to calcium and accumulates in the endothelium of vascular wall or skin, thus causing chronic complications, including obstructive vascular complications and skin itching.

Currently, renal failure is often a complication of diabetes, and thus excessive intake of fruit-sugars can adversely affect on diabetic control. In addition, vitamin C when taken in excessive amounts forms calcium oxalate in vivo, which is a cause of urinary stone, and for this reason, the daily intake of vitamin C should be limited to 100 mg or less in renal failure patients.

### SUMMARY OF THE INVENTION

Accordingly, it is an object of the present invention to provide a method for preparing a purified beverage for renal failure patients, in which potassium and phosphorus are removed from the beverage such that the beverage can be taken by renal failure patients, and also in which the glucose or vitamin content of the beverage is controlled such that it is suitable for renal failure patient, and a purified beverage for renal failure patients prepared by the method.

To achieve the above object, in one aspect, the present invention provides a method for preparing a purified beverage for renal failure patients, the method comprising: introducing a raw beverage containing a high concentration of phosphorus or potassium into a filter unit such that the raw beverage flows through inner side of hollow fibers in a first direction; and introducing a perfusion into the filter unit such that the perfusion flows through outside of hollow fibers in a second direction, whereby phosphorus or potassium in the raw beverage moves to the perfusion fluid(dialysate), thereby preparing a purified beverage containing a low concentration of phosphorus or potassium.

In one embodiment, the filter unit of dialyzer is a bundle of hundreds of hollow fibers which are made of porous semi-permeable membrane, and the raw beverage containing a high concentration of phosphorus or potassium is introduced into the filter unit in a first direction such that it flows through inner side of hollow fibers.

In one embodiment of the present invention, the semi-permeable membrane has pores permeable to molecules having a size of 500 dalton or less.

In one embodiment of the present invention, the first direction is opposite to the second direction.

In one embodiment of the present invention, the raw beverage containing a high concentration of phosphorus or potassium may be introduced into the inner side of filter unit in a first direction at a flow rate of 150-300 ml/min.

In one embodiment of the present invention, the perfusion may be introduced into the outside of filter unit in a second direction at a flow rate of 500-700 ml/min.

In one embodiment of the present invention, the perfusion may be pure water only.

In one embodiment of the present invention, the perfusion may contain ion exchange resin. The ion exchange resin may be calcium polystyrene sulfonate.

In one embodiment of the present invention, the perfusion may contain the same concentration of glucose as that of the raw beverage, and citric acid or calcium can be added if necessary.

In one embodiment of the present invention, the raw beverage may include one of fruit juice, vegetable juice, milk, and soy milk.

In another aspect, the present invention provides a purified beverage for renal failure patients prepared by the above-described method of the present invention.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a schematic view showing an apparatus for preparing a purified beverage according to one embodiment of the present invention;

FIG. 2 is a cross-sectional view of the beverage purification filter (dialyzer) 100 which is included in an apparatus for preparing a purified beverage for renal failure patients;

FIG. 3 is a schematic view showing the flow directions of a raw beverage and a perfusion in each hollow fiber of purification filter according to one embodiment of the present invention;

FIG. 4 is a schematic view showing mass exchange occurring through a semi-permeable membrane according to one embodiment of the present invention; and

FIG. 5 is a flow chart showing a method for preparing a purified beverage according to one embodiment of the present invention.

### DETAILED DESCRIPTION OF THE INVENTION

Hereinafter, a method for preparing a purified beverage for renal failure patients according to the present invention and a purified beverage for renal failure patients prepared by the method will be described in detail with reference to the accompanying drawings.

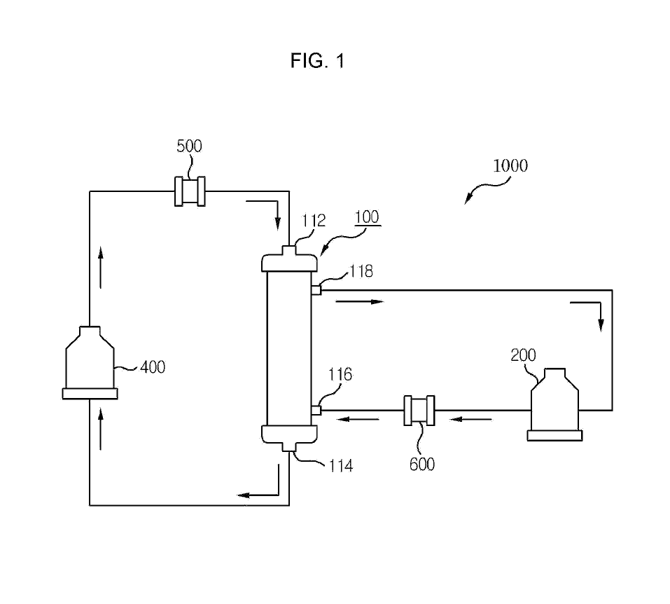

FIG. 1 is a schematic view showing an apparatus for preparing a purified beverage according to one embodiment of the present invention.

As shown in FIG. 1, an apparatus 1000 for preparing a purified beverage may comprise a beverage purification filter (dialyzer) 100, a perfusion tank 200, a raw beverage tank 400, a raw beverage pump 500, and a perfusion pump 600.

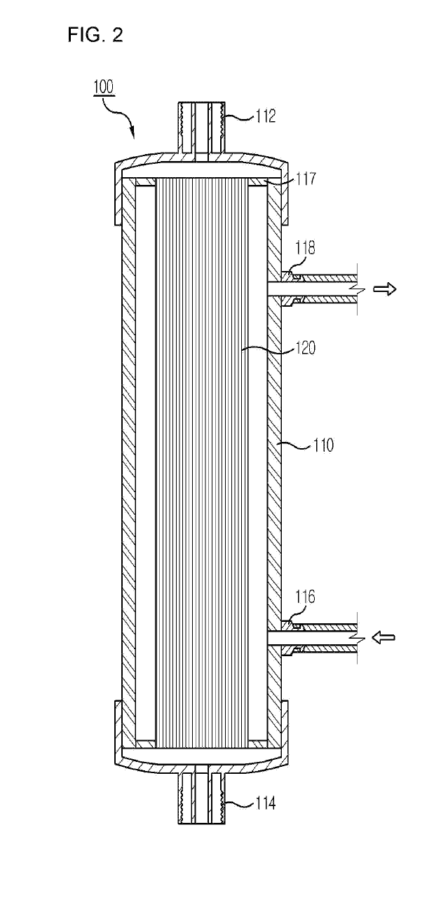

The beverage purification filter 100 comprises a raw beverage inlet 112, a beverage outlet 114, a perfusion inlet 116, and a perfusion outlet 118. A beverage 111 introduced through the beverage inlet 112 and a perfusion 115 introduced through the perfusion inlet 116 are allowed to flow in opposite directions along both sides of semi-permeable membrane of each hollow fiber (corresponding to a filter unit; 120 in FIG. 2), respectively, such that the raw beverage 111 containing a high potassium or phosphorus content is efficiently purified. Hereinafter, the present invention will be described in further detail with reference to FIG. 1&2

The perfusion tank 200 is disposed to operate with the fusion pump 600 and serves to supply the perfusion 115 to the beverage purification filter 100. Herein, the perfusion 115 may be a solution of calcium polystyrene sulfonate (ion exchange resin) in drinkable clean water. Alternatively, the perfusion 115 may also be pure water or glucose-containing water.

The raw beverage tank 400 is disposed to operate with the raw beverage pump 500 and serves to supply the raw beverage 111 to the beverage purification filter 100. The raw beverage 111 may be fruit juice, vegetable juice or the like.

The purified beverage-preparing apparatus 1000 has a structure in which the raw beverage 111 stored in the raw beverage tank 400 is introduced into the beverage purification filter 100 through the raw beverage inlet 112 by operation of the raw beverage pump 500, and the perfusion 115 is introduced from the perfusion tank 200 through the perfusion inlet 116 into the beverage purification filter 100 by operation of the perfusion pump 600 and the raw beverage and the perfusion are circulating through inner and outside of the semi-permeable membrane of the filter unit 100 in opposite directions. The concrete construction and operation of the purified beverage-preparing apparatus 1000 will be described with reference to FIGS. 2 to 4.

FIG. 2 is a cross-sectional view of the beverage purification filter 100 which is included in the apparatus for preparing a purified beverage for renal failure patients.

As shown in FIG. 2, the beverage purification filter 100 comprises a housing 100, a raw beverage inlet 112, a beverage outlet 114, a perfusion inlet 116, a perfusion outlet 118, and bundle of hundreds of hollow fibers made of semi-permeable membrane 120 (filter unit).

The filter unit 120 is a bundle of several hundred hollow fibers made of semi-permeable membrane. The semi-permeable membrane 120 may be made of kinds of semi-permeable materials. Also, the filter unit 120 is supported by tube sheets 117 at the top and bottom of the housing 110.

The raw beverage 111 containing a high concentration of phosphorus or potassium to be filtered out is introduced into the raw beverage inlet 112, and the perfusion 115 is introduced through the perfusion inlet 116 into the housing 110 including the filter unit made of semi-permeable membrane 120.

The housing 110 is made of polycarbonate, such that it should not be deformed in, for example, a sterilization process after preparation of the purified beverage.

The raw beverage inlet 112 and the beverage outlet 114 need to be specifically managed, because they come into direct contact with the raw beverage 111, unlike the housing 110. The raw beverage inlet 111 and the beverage outlet 114 may be inserted with an 0-ring of silicone or fixed to the housing 110 by, for example, ultrasonic welding, in order to prevent leakage there from. The gap between the housing 110 and the raw beverage inlet 112 and the gap between the housing 110 and the beverage outlet 114 are hermetically sealed by a potting process, thereby completing the sealing of the beverage purification filter 100.

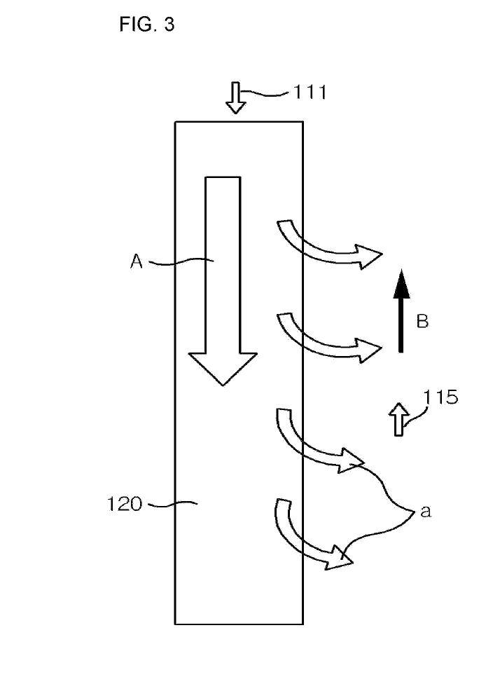

FIG. 3 is a schematic view showing the flow directions of the raw beverage 111 and the perfusion 115 according to one embodiment of the present invention. As shown in FIG. 3, the perfusion 115 is allowed to flow along one side of the semi-permeable membrane 120 in the “B” direction, and the raw beverage 111 containing a high concentration of phosphorus or potassium to be filtered out is allowed to flow along the other side of the semi-permeable membrane 120 in the “A” direction. Herein, small molecules 720 in the raw beverage 111 flow out through semi-permeable pores 700 in the “a” direction.

Referring to FIG. 3, the perfusion 115 and the raw beverage 111 containing a concentration of phosphorus or potassium are allowed to flow along both sides of the semi-permeable membrane 120, respectively, in opposite direction at high speed. Herein, the area of contact between the raw beverage 111 and the perfusion 115 is maximized, so that osmosis, ultrafiltration, diffusion, solvent drag, etc. occur through the semi-permeable membrane 120, and rapid mass transfer there between occurs through the semi-permeable membrane 120.

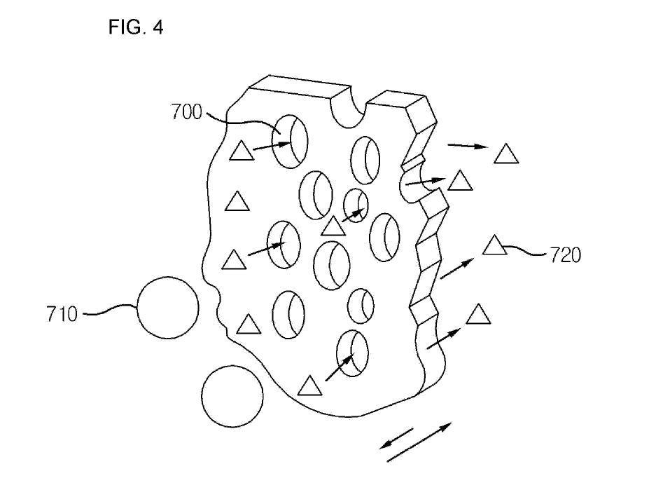

FIG. 4 is a schematic view showing mass exchange occurring through the semi-permeable membrane according to one embodiment of the present invention. As shown in FIG. 4, large molecules 710 (including particles, molecules, ions, etc.) larger than semi-permeable pores 700 do not pass through the semi-permeable membrane 120, whereas small molecules 720 (including particles, molecules, ions, etc.) pass through the semi-permeable pores 700, whereby a purified beverage containing a low concentration of phosphorus or potassium can be produced form the raw beverage 111 containing a high concentration of phosphorus or potassium. If the size of the semi-permeable pores 700 is excessively large, an excessive amount of the effective components of the raw beverage can pass through the semi-permeable membrane. For this reason, a low flux membrane having a size of 1.8 m² may be used. Specifically, the pores 700 of the semi-permeable membrane are permeable to molecules having a size of 500 dalton or less, such that water-soluble ions, glucose and the like having a size of 500 dalton or less easily pass except most of solid components through the semi-permeable membrane due to diffusion caused by the difference in concentration from the perfusion 115. Herein, highly water-soluble potassium is rapidly removed due to diffusion caused by the difference in concentration between the two solutions, and thus can be removed within a short time of about 30 minutes while the removal of other components is minimized. Although potassium is easily removed without having to use any potassium removal agent, a calcium polystyrene sulfonate (ion exchange resin) which is currently used to treat hyperkalemia in renal failure patients may be added to the perfusion 115 in order to minimize the removal of other useful components and increase the efficiency of potassium removal. The ion exchange resin calcium polystyrene sulfonate that acts to replace potassium with calcium serves to remove potassium hazardous to renal failure patients and has the effect of supplementing calcium which is deficient in the case of renal failure patients (indeed, most renal failure patients takes a large amount of calcium every day) and functions to remove phosphorus. Thus, the ion exchange resin calcium polystyrene sulfonate can also exhibit the effect of reducing the daily dosage of calcium.

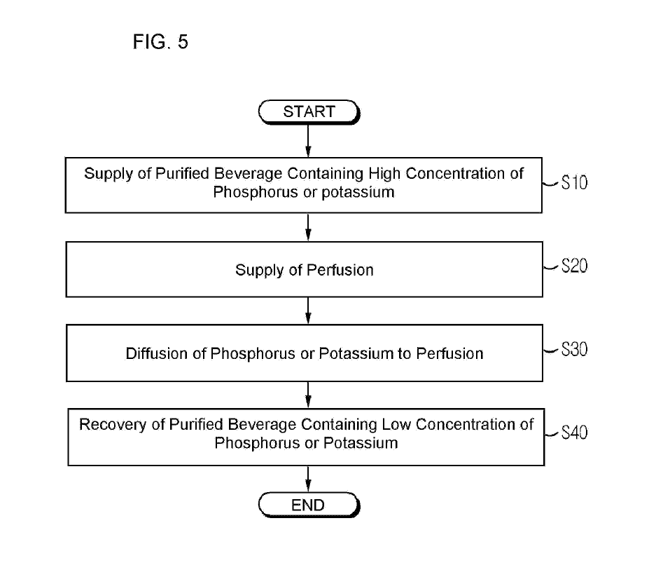

FIG. 5 is a flow chart showing a method for preparing a purified beverage according to one embodiment of the present invention. As shown in FIG. 5, the raw beverage 111 containing a high concentration of phosphorus or potassium is allowed to flow through inner side of the beverage purification filter 100 in the “A” direction (see FIG. 3) (S10). Meanwhile, the perfusion 115 is introduced into outside the filter membrane 100 such that it flows in the “B” direction (S20). Then, the raw beverage 111 containing a high concentration of phosphorus or potassium and the perfusion 115 flow in opposite directions along both sides of the filter unit (semi-permeable membrane) 120, respectively, at high speed, so that the area of contact between the two solutions are maximized, whereby osmosis, ultrafiltration, diffusion , solvent drag, etc. occurs through the membrane, and rapid mass exchange occurs through the membrane (S30). The flow rate is 500-700 ml/min for the perfusion 300-500 ml/min for the raw beverage. When the flow rate of the raw beverage 11 is set at up to 300-500 ml/min, the purification there of can be accomplished only within 10 minutes. When the flow rate of the raw beverage is set at 160 ml/min as described below, the time required to prepare the purified beverage is about 30 minutes. The experimental data will be described below. The raw beverage 111 containing a high concentration of phosphorus or potassium is subjected to diffusion, osmosis, ultrafiltration and solvent drag into the perfusion, whereby a purified beverage containing a low concentration of phosphorus or potassium is obtained (S40). Herein, the flow rate of the perfusion or the raw beverage can be varied depending on the type of semi-permeable membrane, the size of the semi-permeable membrane, pore size and the purification co-efficiency.

The effects of the embodiment of the present invention, which has the above-described construction, will be described with reference to the following table.

As described above, for the filtration of the raw beverage, the flow rate was set at 600 ml/min for the perfusion 115 and 160 ml/min for the raw beverage, and the filtration process was carried out for 30 minutes. Herein, the perfusion was a solution of 200 mg/l of glucose, 2.2 mg/l of calcium and 1.9 mEq/L of potassium in drinkable clean water.

2.84 liters of orange juice was dialyzed, and then the concentrations of potassium, calcium, phosphorus and glucose in the juice were measured at 5 minute-intervals. The results of the measurement are shown in Table 1 below.

TABLE 1

| | 0 (before | After | After | After | After | After | After |
|---|---|---|---|---|---|---|---|
| | treatment) | 5 min | 10 min | 15 min | 20 min | 25 min | 30 min |
| Potassium | 48.4 | 35.5 | 21.4 | 15.4 | 12.3 | 9.2 | 7.8 |
| (mEq/L) | | | | | | | |
| Calcium | 11 | 10.1 | 9.4 | 8.6 | 8.0 | 7.7 | 7.5 |
| (mg/dl) | | | | | | | |
| Phosphorus | 12.6 | 9.11 | 5.31 | 3.77 | 2.99 | 2.24 | 1.83 |
| (mg/dl) | | | | | | | |
| Glucose | 2661 | 1992 | 1196 | 865 | 711 | 548 | 455 |
| (mg/dl) | | | | | | | |

The phosphorus, calcium and potassium concentrations of the perfusion 115 are shown in Table 2 below.

| | |
|---|---|
| Potassium (mg/dl) | 0.01 |
| Calcium (mg/dl) | 2.2 |
| Potassium (mEq/L) | 1.9 |

As can be seen from the results in the Tables, the rate of removal of potassium from the orange juice was 55.8% at 10 min, 74.6% at 20 min, and 84% at 30 min. Also, the rate of calcium from the orange juice was 14.5% at 10 min, 27.2% at 20 min, and 31.8% at 30 min. The reason why the removal rate of calcium from the orange juice was relatively low as described above is that calcium is added into the perfusion 115 at concentration of 2.2 mg/dl at which the diffusion rate of calcium was slow. This indicates that, if it is not desired to remove calcium, the concentration of calcium in the perfusion is increased. Thus, the amounts of components to be kept and components to be removed can be controlled by controlling the concentrations of components in the perfusion. Also, glucose harmful to diabetic patients can be removed according to this principle. Moreover, for patients other than diabetic patients, a purified beverage having the same glucose content as that of a raw beverage can be prepared by adding glucose to a perfusion to the same glucose concentration as that of the raw beverage.

The above-described method of the present invention can be applied to a wide range of applications, including powder-form juice, low-potassium vegetable porridge, low-phosphorus yogurt, low-phosphorus cheese, jelly, jam, pudding, etc. In addition, because processes for preparing raw beverages do not require specific conditions, the method of the present invention can be applied to a variety of beverage products.

According to the embodiment of the present invention as described above, potassium and phosphorus harmful to renal failure patients can be removed from fruit juice, vegetable juice, etc., thereby providing beverages safe for renal failure patients. When the technology of the present invention is applied, raw materials for preparing beverages or processed foods from which certain materials harmful to groups of patients were removed can be prepared by controlling the components of the perfusion 115. Also, raw materials prepared according to the present invention can be used to prepare a wide range of processed foods, including powder-form juice, low-potassium vegetable porridge, low-phosphorus yogurt, low- phosphorus cheese, jelly, jam, pudding, etc. In addition, because processes for preparing raw juice do not require specific conditions, the method of the present invention can be applied to a variety of beverage products. Moreover, the method of the present invention is time-saving and cost-effective, because it can achieve the purification of raw beverages within a short time of about 30 minutes and can continuously prepare large amounts of purified beverages.

Although the preferred embodiment of the present invention has been described for illustrative purposes, those skilled in the art will appreciate that various modifications, additions and substitutions are possible, without departing from the scope and spirit of the invention as disclosed in the accompanying claims.

1. A method for preparing a purified beverage for renal failure patients, the method comprising:
introducing a raw beverage containing a high concentration of phosphorus or potassium into a filter unit such that the raw beverage flows through inner side of the filter unit in a first direction; and
introducing a perfusion into the filter unit such that the perfusion flows through outside of the filter unit in a second direction, whereby phosphorus or potassium in the raw beverage moves to the perfusion, thereby preparing a purified beverage containing a low concentration of phosphorus or potassium, and the purified beverage is circulating to the raw beverage tank,
wherein the filter unit is a bundle of hundreds of hollow fibers which is made of porous semi-permeable membrane, the perfusion contains the same concentration of glucose as that the raw beverage, citrate, or calcium, wherein the semi-permeable membrane has pores permeable to molecules having a size of 500 dalton or less.

2-3. (canceled)

4. The method of claim 1, wherein the first direction is opposite to the second direction.

5. The method of claim 1, wherein the raw beverage containing a high concentration of phosphorus or potassium is introduced into the inner side of the filter unit at a flow rate of 300-500 ml/min.

6. The method of claim 5, wherein the perfusion is introduced into the outside of the filter unit in a second direction at a flow rate of 500-700 ml/min. Wherein the perfusion is pure water.

7. (canceled)

8. The method of claim 1, wherein the perfusion is water containing ion exchange resin.

9. The method of claim 8, wherein the ion exchange resin is calcium polystyrene sulfonate.

10. (canceled)

11. The method of claim 1, wherein the raw beverage includes one of fruit juice, vegetable juice, milk, and soy milk.

12. A purified beverage for renal failure patients prepared according to the method of claim 1.
